(19) United States
(12) Patent Application Publication
(10) Pub. No.: US 2025/0343480 A1
(43) Pub. Date: Nov. 6, 2025

(54) SYMMETRIC BIDIRECTIONAL RESONANT CONVERTER

(71) Applicant: FUTURi POWER INC., Vancouver (CA)

(72) Inventors: Hao Chen, Hangzhou (CN); Martin Ordonez, Vancouver (CA)

(21) Appl. No.: 18/989,828

(22) Filed: Dec. 20, 2024

Related U.S. Application Data
(60) Provisional application No. 63/642,794, filed on May 5, 2024.

(51) Int. Cl. H02M 3/00; H02M 1/00; H02M 3/335; H02M 5/293; H02M 7/00; H02M 7/797

(52) U.S. Cl. CPC H02M 3/01; H02M 1/0058; H02M 1/007; H02M 3/003; H02M 3/33573; H02M 3/33584; H02M 5/293; H02M 7/003; H02M 7/797

(57) ABSTRACT

When existing power converters are used bidirectionally, they may be limited by efficiency or restricted conversion ranges. Disclosed herein is a symmetric bidirectional resonant converter. The converter is suitable for both DC-to-DC, AC-to-DC and AC-to-AC conversion. The converter includes a first switch network, a first transformer, a resonant tank, a second transformer, and a second switch network. The converter has a symmetrical structure, providing more degrees of freedom for the design of resonant component parameters while achieving bidirectional power transmission, and can achieve high bidirectional voltage-conversion ratios. The converter's semiconductor and resonant components provide both output voltage regulation and soft switching in both power conversion directions, which enhances power conversion efficiency.

### TECHNICAL FIELD

This application relates resonant converters, and more particularly, to a symmetric bidirectional power converter for DC-to-DC, AC-to-DC and AC-to-AC conversion.

### BACKGROUND

In the realms of energy conservation and environmental protection, which are increasingly gaining prominence, extensive research endeavors have been dedicated to harnessing energy in a manner that is both clean and efficient. Renewable energy resources, such as photovoltaic (PV) and wind power, stand out as promising avenues for generating electricity in an eco-friendly fashion. However, the intermittent nature of these resources poses challenges concerning system stability, reliability and power quality. Energy storage systems (ESSs) are required to deal with such intermittent outages for grid-tied and off-grid applications. Among the various energy storage components, batteries and supercapacitors are the most popular energy storage components, considering their price and performance. The ESSs are expected to have bidirectional power flow capability to store the excess energy generated by renewable resources, and release it when the renewable energy is not sufficient or during peak times of energy consumption. So, the bidirectional converter is a key component in ESSs to enable bidirectional power flow.

Generally, bidirectional converters are designed to have high-power density, high efficiency, and high reliability. Various bidirectional DC-DC topologies have been proposed and studied. For safety considerations, galvanic isolation is usually required. Among the isolated topologies, the dual active bridge (DAB) converter has attracted numerous research interests due to its simple structure, wide-range soft-switching capability, and high efficiency. The DAB converter has two bridge-type switches on each side of the transformer, and the phase shift angle between the primary side switches and the secondary side switches determines the power flow direction and its output power. However, the DAB suffers from high reverse energy and high turn-off power loss, which deteriorates the overall efficiency.

The turn-off power loss is related to the turn-off current, which can be reduced by operating the DAB topology in a resonant mode with an extra resonant capacitor, which forms a resonant DAB converter. Among the resonant DAB converters, the inductor-inductor-capacitor (LLC) resonant converter has superior performance, especially for buck/boost operation capability, narrow switching frequency variation range, and enhanced efficiency (FIG. 1).

For a bidirectional LLC resonant converter, considering that the voltage gain of the switch networks is 1, the forward direction being to the right in FIG. 1, the normalized forward and backward voltage gains can be expressed as follows:

$${Gain}_{( Forward )} = \frac{{n}_{1} {V}_{2}}{{V}_{1}} = \frac{1}{\sqrt{{( {f}_{n} - \frac{1}{{f}_{n}} )}^{2} {Q}_{F}^{2} + {( \frac{1}{k} + 1 - \frac{1}{k {f}_{n}^{2}} )}^{2}}}$$

$${Gain}_{( Backward )} = \frac{{V}_{1}}{{n}_{1} {V}_{2}} = \frac{1}{\sqrt{{( {f}_{n} - \frac{1}{{f}_{n}} )}^{2} {Q}_{B}^{2} + 1}}$$

$$where$$

$$\{ \begin{matrix}k = \frac{{L}_{m}}{{L}_{r}} , {f}_{n} = \frac{f}{{f}_{0}} \\ {f}_{0} = \frac{1}{2 π \sqrt{{L}_{r} {C}_{r}}} \\ {Q}_{F} = \frac{\sqrt{{L}_{r} / {C}_{r}}}{{n}^{2} {R}_{eq\_F}} , {Q}_{B} = \frac{\sqrt{{L}_{r} / {C}_{r}}}{{R}_{eq\_B}}\end{matrix}$$

V₁: source voltage (forward mode)/load voltage (backward mode)
V₂: load voltage (forward mode)/source voltage (backward mode)
Lₘ: transformer magnetizing inductance
Lᵣ: resonant inductance
Cᵣ: resonant capacitance
n: transformer turn ratio, and 1/n is rated converter forward voltage gain, n is rated converter backward voltage gain
f₀: resonant frequency
f: operation frequency
fₙ: normalized operation frequency
R_{eq}: equivalent load resistance, forward mode (R_{eq_F}), backward mode (R_{eq_B})
k: resonant inductance ratio
Q: quality factor, forward mode (Q_{F}), backward mode (Q_{B})

When Q and k are determined, then by changing the operation frequency f, an LLC resonant converter can provide a wide voltage gain range in forward operation mode. However, its normalized backward gain range is always less than unity according to the above equation. Therefore, LLC resonant converters are limited in bidirectional applications.

Some engineers have proposed a bidirectional capacitor-inductor-inductor-capacitor (CLLC) resonant converter (FIG. 2) with a resonant tank in each of the transformer primary side and transformer secondary side. Considering that the voltage gain of the switch networks is 1, its normalized forward and backward voltage gains can be expressed as follows by using symmetric parameter design:

$${Gain}_{( Forward )} = \frac{{n}_{1} {V}_{2}}{{V}_{1}} = \frac{1}{\sqrt{{a}^{2} + {b}_{F}^{2}}}$$

$${Gain}_{( Backward )} = \frac{{V}_{1}}{{n}_{1} {V}_{2}} = \frac{1}{\sqrt{{a}^{2} + {b}_{B}^{2}}}$$

$$a = \frac{1}{k} + 1 - \frac{1}{k \cdot {f}_{n}^{2}}$$

$${b}_{F} = ( \frac{1}{k} + 2 ) {Q}_{F} \cdot {f}_{n} - ( \frac{2}{k} + 2 ) \frac{{Q}_{F}}{{f}_{n}} + \frac{{Q}_{F}}{k \cdot {f}_{n}^{3}}$$

$$\{ \begin{matrix}{L}_{r 1} = {n}^{2} {L}_{r 2} , {C}_{r 1} = \frac{{C}_{r 2}}{{n}^{2}} \\ k = \frac{{L}_{m}}{{L}_{r 1}} , {f}_{n} = \frac{f}{{f}_{0}} , {f}_{0} = \frac{1}{2 π \sqrt{{L}_{r 1} {C}_{r 1}}} \\ {Q}_{F} = \frac{\sqrt{{L}_{r 1} / {C}_{r 1}}}{{n}^{2} {R}_{eq\_F}} , {Q}_{B} = \frac{\sqrt{{L}_{r 1} / {C}_{r 1}}}{{R}_{eq\_B}}\end{matrix}$$

By including the second resonant tank, CLLC converters can realize a proper voltage gain range in both forward mode and backward mode. However, the extra resonant tank increases both the cost and volume of the converter, and the voltage gain is reduced compared with the traditional LLC converter. More importantly, since f₀ is usually fixed at the beginning of designing a resonant converter, R_{eq} is determined by converter rated power and voltage, and n is determined by converter rated input and output voltage, which are already determined before the design of the k value and Q value, so, according to the above equations, in order to meet the gain range requirements, the only way is to carefully design the k value and Q value. Once k and Q are determined, the resonant parameters Lₘ, Lᵣ₁, Lᵣ₂, Cᵣ₁, Cᵣ₂ are also determined and cannot be varied. In some special scenarios, such as involving a high voltage conversion ratio, extreme resonant parameters that cannot be actually or practically achieved may be required. For example, in forward mode, the source voltage is 400V, load voltage is 40V, rated power is 3 kW, transformer turn ratio n=10 and resonant frequency f₀=100 kHz. The parameters k=4, Q_{F}=Q_{B}=0.4 are chosen to meet gain range requirements. Then, the final resonant parameters are Lₘ=110 uH, Lᵣ₁=27.5 uH, Lᵣ₂=0.275 uH, Cᵣ₁=92.1 nF, Gᵣ₂=9210 nF. The value of Lᵣ₂ is too small to be realized in practice. Therefore, CLLC converters are not suitable for applications with high voltage conversion ratios due to the design limitations of resonant component parameters.

Some engineers have proposed to parallelize an inductor on the output of the LLC primary side switch network and form an equivalent symmetrical three inductor and capacitor (L3C) topology (FIG. 3). Considering that the voltage gain of the switch networks is 1, its normalized forward and backward voltage gains can be expressed as follows by using symmetric parameter design:

$${Gain}_{( Forvard )} = \frac{{n}_{1} {V}_{2}}{{V}_{1}} = \frac{1}{\sqrt{{( {f}_{n} - \frac{1}{{f}_{n}} )}^{2} {Q}_{F}^{2} + {( \frac{1}{k} + 1 - \frac{1}{{kf}_{n}^{2}} )}^{2}}}$$

$${Gain}_{( Backward )} = \frac{{V}_{1}}{{n}_{1} {V}_{2}} = \frac{1}{\sqrt{{( {f}_{n} - \frac{1}{{f}_{n}} )}^{2} {Q}_{B}^{2} + {( \frac{1}{k} + 1 - \frac{1}{{kf}_{n}^{2}} )}^{2}}}$$

$$where$$

$$\{ \begin{matrix}{L}_{m} = {L}_{ext} , k = \frac{{L}_{m}}{{L}_{r}} , {f}_{n} = \frac{f}{{f}_{0}} , {f}_{0} = \frac{1}{2 π \sqrt{{L}_{r} {C}_{r}}} \\ {Q}_{F} = \frac{\sqrt{{L}_{r} / {C}_{r}}}{{n}^{2} {R}_{eq\_F}} , Q B = \frac{\sqrt{{L}_{r} / {C}_{r}}}{{R}_{eq\_B}}\end{matrix}$$

Due to the paralleled inductor Lₑₓₜ, this topology improves backward gain. However, due to the incomplete symmetry in the circuit structure, the design of resonant component parameters is also limited in high voltage conversion ratio applications. For example, in forward mode, the source voltage is 40V, load voltage is 400V, rated power is 3 kW, transformer turn ratio n=0.1 and the resonant frequency f₀=100 kHz. The parameters k=4, Q_{F}=Q_{B}=0.4 are chosen to meet gain range requirements. Then, the final resonant parameters are Lₘ=Lₑₓₜ=1.1 uH, Lᵣ=0.275 uH, Cᵣ=9210 nF. The values of Lₑₓₜ, Lₘ, and Lᵣ are too small to be realized in practice.

This background is not intended, nor should be construed, to constitute prior art against the present invention.

### SUMMARY OF INVENTION

It is an objective of the present invention to provide a symmetric, bidirectional, resonant converter topology. This topology inherits the advantages of low power loss and wide voltage conversion range of LLC resonant converters, and compared to existing topologies, it is suitable for a wider voltage conversion range, especially in situations with a high voltage conversion ratio.

In order to achieve the above and optionally other objectives, the present invention adds an additional transformer to the traditional LLC resonant converter, forming a completely symmetric structure with two transformers. The disclosed converter may be referred to as a two-transformer LLC (2T-LLC) converter. The turn ratio of this additional transformer adds a degree of freedom to the design of the resonant parameters of the converter, allowing the resonant parameters to be adjusted to better meet practical needs while meeting the converter voltage gain range requirements. Therefore, this topology can overcome the parameter design limitations of existing resonant converters at high voltage conversion ratio and expand the applicability of resonant converters. At the same time, this conversion is not only suitable for DC-to-DC conversion, but also for AC-to-AC conversion, and in some embodiments can achieve the above advantages in both application scenarios. Also, with additional switch networks configured as converters (inverters and/or rectifiers) that are connected upstream or downstream of the 2T-LLC, it can also be used for AC-DC conversion and DC-AC conversion.

Disclosed herein is a resonant converter circuit comprising: a first switch network; a first transformer having a first winding connected to the first switch network; a second switch network; a second transformer having a first winding connected to the second switch network; and a loop comprising an inductor, a capacitor, a second winding of the first transformer and a second winding of the second transformer.

Also disclosed herein is a method for transferring power by a resonant converter circuit that comprises: three or more ports; three or more switch networks each connected to a different one of said ports; three or more transformers each having a first winding connected to a different one of said switch networks; and a loop comprising an inductor, a capacitor, and a second winding of each of said transformers; the method comprising: receiving two or more power inputs, each to a different one of said ports; and switching each switch network that receives one of said power inputs so that it is switched with a phase difference relative to at least one other switch network that receives one of said power inputs.

Further disclosed herein is a method for transferring power by a resonant converter circuit that comprises: three or more ports; three or more switch networks each connected to a different one of said ports; three or more transformers each having a first winding connected to a different one of said switch networks; and a loop comprising an inductor, a capacitor, and a second winding of each of said transformers; the method comprising: providing two or more power outputs, each from a different one of said switch networks via its corresponding port; and switching each switch network that provides one of said power outputs so that it is switched with a phase difference relative to at least one other switch network that provides one of said power outputs.

This summary provides a simplified, non-exhaustive introduction to some aspects of the invention, without delineating the scope of the invention.

### BRIEF DESCRIPTION OF DRAWINGS

Embodiments of the invention can be found in the following drawings which should not be construed as restricting the scope of the invention in any way.

FIG. 1 is a prior art bidirectional LLC resonant converter.

FIG. 2 is a prior art bidirectional CLLC resonant converter.

FIG. 3 is a prior art bidirectional L3C resonant converter.

FIG. 4 is a symmetric, bidirectional resonant converter, according to an embodiment of the present invention.

FIG. 5 is a schematic circuit of an example of the present invention for DC-to-DC conversion.

FIG. 6 shows key switch waveforms of the symmetric bidirectional resonant converter shown in FIG. 5.

FIG. 7 is a schematic circuit of an example of the present invention for AC-to-AC conversion.

FIG. 8 shows key switch waveforms of the symmetric bidirectional resonant converter shown in FIG. 7.

FIG. 9 is a schematic circuit of another example of the present invention shown for AC to AC conversion.

FIG. 10 shows key switch waveforms of the symmetric bidirectional resonant converter shown in FIG. 9.

FIG. 11 is a schematic circuit of a multiport converter, according to an embodiment of the present invention.

FIG. 12 is a schematic circuit of a five port converter, according to an embodiment of the present invention.

FIG. 13 shows waveforms of a five port converter with two enabled sources and two loads, according to an embodiment of the present invention.

FIG. 14 shows drive signals for source-side phase shift modulation, according to an embodiment of the present invention.

FIG. 15 shows waveforms of a five port converter with three phase-shifted sources and two loads, according to an embodiment of the present invention.

FIGS. 16-20 are schematic drawings of different transformer architectures for use in embodiments of the present invention.

FIG. 21 is a prior art bidirectional L3C resonant converter.

FIG. 22 is a symmetric, bidirectional resonant converter, according to an embodiment of the present invention.

FIG. 23 is a schematic circuit of an example of the present invention for AC-to-DC conversion.

FIG. 24 is a schematic circuit of an example of the present invention for a three-phase converter.

### DESCRIPTION

### A. Glossary

AC—Alternating current

Bidirectional switch: a switch that can conduct current in both directions when on and block voltage in both directions when off.
DAB—Dual active bridge
DC—Direct current
ESS—Energy storage system
CLLC—A converter topology having a resonant loop with capacitor-inductor-inductor-capacitor structure
IGBT—Insulated gate bipolar transistor
L3C—A converter topology having a resonant loop with three inductors and a capacitor.
LLC—A converter topology having a resonant loop with two inductors and a capacitor.

Magnetizing inductance—This is the inductance of a transformer winding as it appears to the circuit loop to which it is connected. In circuit analysis it is often drawn separately from the transformer, which is considered to be an ideal transformer.

Matrix rectifier/matrix inverter: full bridge converter with bidirectional switches.
MOSFET—Metal oxide semiconductor field effect transistor
PV—Photovoltaic

Soft switching: in power electronics this is a technique used to reduce switching losses and stress on semiconductor devices by ensuring transitions occur under favorable conditions, such as zero or near-zero voltage or current. This approach minimizes energy dissipation during switching, reduces electromagnetic interference (EMI), and enhances the reliability and efficiency of the system. Common methods include Zero-Voltage Switching (ZVS), where the switch operates at zero or near-zero voltage, and Zero-Current Switching (ZCS), where the switch operates at zero or near-zero current. Compared to hard switching, any reduction of the voltage or current during the switching transition is beneficial and the greater the reduction, the greater the benefit. In some cases “near-zero” may be understood to be a reduction to 10% or less; in more demanding situations it may be understood to be a reduction to 1% or less.

ZCS—Zero-current switching, the switch turns off when the current flowing through it has decreased to zero, or turns on when the current is zero or about to start flowing.

ZVS—Zero-voltage switching, the switch turns on when the voltage across it is zero, or turns off when the voltage across it is zero or about to become zero.

### B. Exemplary Embodiments

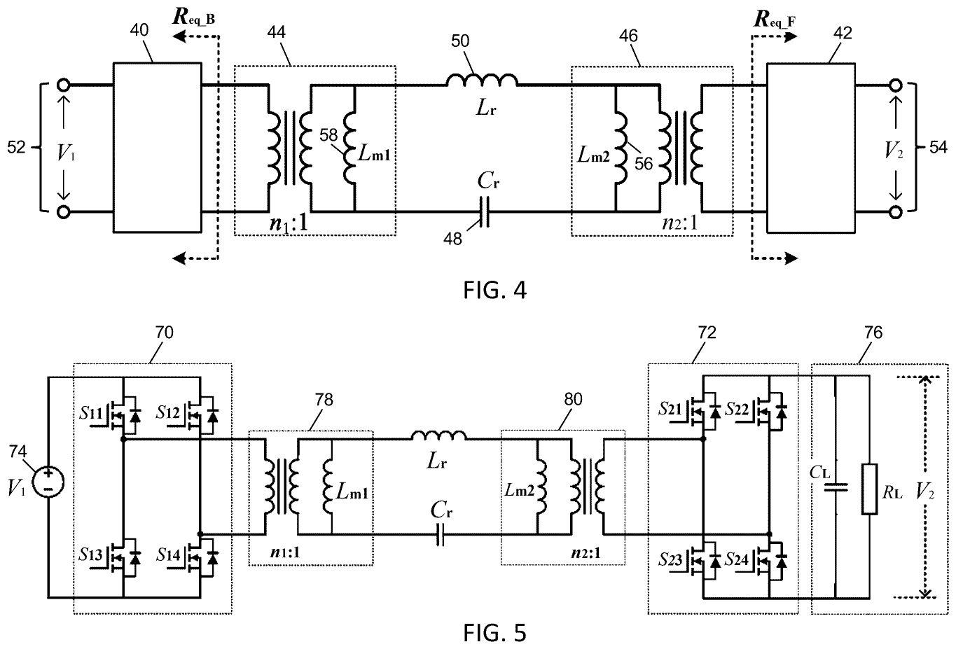

An example circuit topology of the present invention is shown in FIG. 4, including a first switch network 40, a second switch network 42, a first transformer 44, a second transformer 46, a resonant capacitor 48, and a resonant inductor 50. The right-hand side of the first switch network 40 is connected with the left-hand side of the first transformer 44, the right-hand side of the first transformer is connected in series with the resonant capacitor 48, the resonant inductor 50, and the left-hand side of the second transformer 46. The right-hand side of the second transformer is connected with the left-hand side of the second switch network 42. The circuit may equally well be described in terms of the input and output sides of its various components and modules, provided that the direction of power transfer is stated.

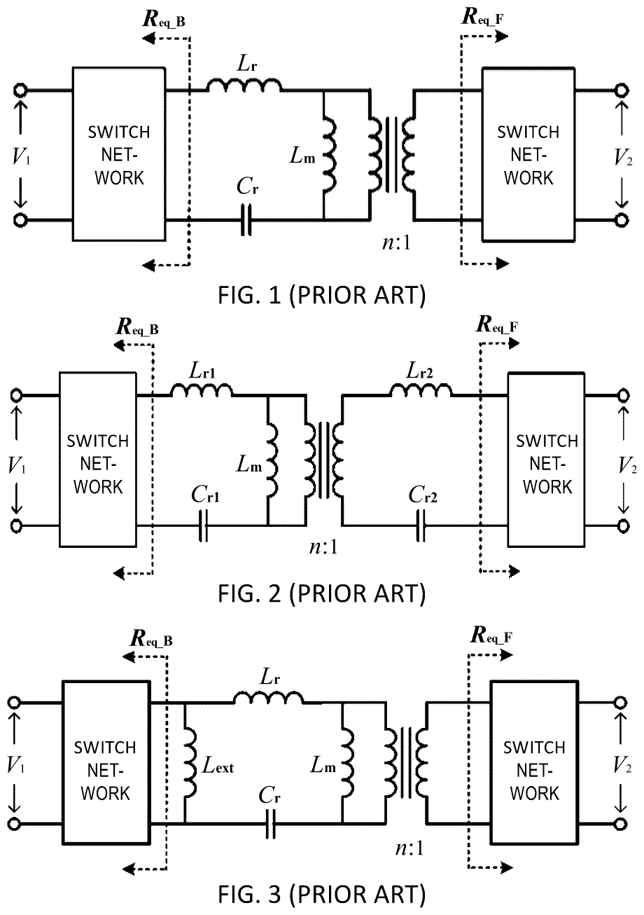

It can be seen that the difference between the present invention and the existing LLC topology (FIG. 1) is that the topology of the present invention adds an additional transformer 44, making the circuit structure completely symmetrical, so that the present invention has the same circuit characteristics during forward power transmission and backward power transmission. Therefore, the present invention is especially suitable for bidirectional power transmission.

In the case of power transfer from the left-hand side to the right-hand side of the circuit shown in FIG. 4, i.e. in the forward direction, the left-hand side of the first switch network 40 is connected to a voltage source 52, which can be a DC source or an AC source, its voltage value being V₁. The DC source can be a solar panel array, or an energy storage device that includes rechargeable batteries, fuel cells and/or the like. The AC source can be a grid, an AC generator and/or the like. The right-hand side of the second switch network 42 is connected to a voltage load 54, which can be a DC load or an AC load, depending on the type of the source, and its voltage value is V₂. Alternatively, the voltage source and load may refer to upstream or downstream converters coupled to the converter of FIG. 4. The first switch network 40, which can be a half-bridge inverter, a full-bridge inverter or a push pull inverter, is responsible for producing a square-wave voltage waveform with a variable duty cycle and variable frequency on its right-hand side. More generally, the first switch network may be described as a half-bridge converter, a full-bridge converter or a push-pull converter. The first transformer 44 transfers and optionally voltage-converts the square-wave voltage waveform to its right-hand side. The amplitude of the square-wave voltage waveform is changed according to the first transformer's turn ratio, while maintaining its duty cycle and frequency unchanged.

After passing the series-connected resonant capacitor 48 and resonant inductor 50, the square-wave voltage waveform is transferred and optionally voltage-converted by the second transformer 46 to the second switch network 42. The second switch network, which can be a half-bridge rectifier, a full-bridge rectifier or a push pull rectifier, is responsible for rectifying the square-wave voltage waveform to provide to the load 54. More generally, the second switch network may be understood to be a half-bridge converter, a full-bridge converter or a push-pull converter.

During this process, the resonant inductor Lᵣ 50, the magnetizing inductor Lₘ₂ 56 of the second transformer 46 and the resonant capacitor Cᵣ 48 form an LLC resonant tank, which is the same kind of resonant tank as in the traditional LLC converters. Therefore, the resonant tank can provide zero-voltage switching (ZVS) to switches in the first switch network 40, and zero-current switching (ZCS) to switches in the second switch network 42. So, in the disclosed circuit, the power loss is low due to ZVS and ZCS. The principles of how LLC resonant tanks work have been analyzed in detail in previous research and are known. The magnetizing inductor Lₘ₁ 58 of the first transformer 44 is connected in parallel with the first switch network 40, so it is not involved in resonance, but provides reactive current to the switches in the first switch network, enabling better ZVS operation. It should be noted that when Lₘ₂ 56 is much larger than Lᵣ 50, that is, Lₘ₂ 56 is at least 10 times larger than Lᵣ 50, then the current passing through Lₘ₂ 56 is very small and can be neglected. In this situation, it can be considered that Lₘ₂ 56 has no effect in the resonant circuit, so the circuit behaves like an LC resonant circuit, that is, a series resonant circuit.

In the case of power transfer from the right-hand side to the left-hand side of the circuit shown in FIG. 4, i.e. in the backward direction, the right-hand side of the second switch network 42 is connected to a voltage source, which can be a DC source or an AC source, its voltage value being V₂. The left-hand side of the first switch network 40 is connected to a voltage load, which can be a DC load or an AC load, depending on the type of the source, and its voltage value is V₁. The second switch network, which can be a half-bridge inverter, a full-bridge inverter or a push-pull inverter, is responsible for producing a square-wave voltage waveform with a variable duty cycle and variable frequency on its left-hand side. The second transformer 46 transfers and optionally voltage-converts the square-wave voltage waveform to its left-hand side. The amplitude of the square-wave voltage waveform is changed according to the second transformer's turn ratio, while maintaining its duty cycle and frequency unchanged.

After passing the series-connected resonant capacitor 48 and resonant inductor 50, the square-wave voltage waveform is transferred and optionally voltage-converted by the first transformer 44 to the first switch network 40. The first switch network, which can be a half-bridge rectifier, a full-bridge rectifier or a push-pull rectifier, is responsible for rectifying the square-wave voltage waveform to the load.

During this process, the resonant inductor Lᵣ 50, the magnetizing inductor Lₘ₁ 58 of the first transformer 44, and the resonant capacitor Cᵣ 48 form an LLC resonant tank. Therefore, the resonant tank can provide ZVS to switches in the second switch network, and ZCS to switches in the first switch network. The magnetizing inductor Lₘ₂ of the second transformer 46 is connected in parallel with the second switch network 42, so it is not involved in resonance, but provides reactive current to the switches in the second switch network, enabling better ZVS operation. It should be noted that when Lₘ₁ 58 is much larger than Lᵣ 50, that is, Lₘ₁ 58 is at least 10 times larger than Lᵣ 50, then the current passing through Lₘ₁ 58 is very small and can be neglected. In this situation, it can be considered that Lₘ₁ 58 has no effect in the resonant circuit, so the circuit behaves like an LC resonant circuit, that is, a series resonant circuit.

Considering that the voltage gain of the switch networks is 1, the normalized forward and backward voltage gains of the proposed topology can be expressed as follows by using symmetric parameter design:

$${Gain}_{( Forward )} = \frac{{n}_{1} {n}_{2} {V}_{2}}{{V}_{1}} = \frac{1}{\sqrt{{( {f}_{n} - \frac{1}{{f}_{n}} )}^{2} {Q}_{F}^{2} + {( \frac{1}{k} + 1 - \frac{1}{{kf}_{n}^{2}} )}^{2}}}$$

$${Gain}_{( Backward )} = \frac{{V}_{1}}{{n}_{1} {n}_{2} {V}_{2}} = \frac{1}{\sqrt{{( {f}_{n} - \frac{1}{{f}_{n}} )}^{2} {Q}_{B}^{2} + {( \frac{1}{k} + 1 - \frac{1}{{kf}_{n}^{2}} )}^{2}}}$$

$$where$$

$$\{ \begin{matrix}\begin{matrix}n = {n}_{1} \times {n}_{2} \\ {L}_{m} = {L}_{m 1} = {L}_{m 2}\end{matrix} \\ k = \frac{{L}_{m}}{{L}_{r}} , {f}_{n} = \frac{f}{{f}_{0}} , {f}_{0} = \frac{1}{2 π \sqrt{{L}_{r} {C}_{r}}} \\ {Q}_{F} = \frac{\sqrt{{L}_{r} / {C}_{r}}}{{n}_{2}^{2} {R}_{eq\_F}} , {Q}_{B} = \frac{\sqrt{{L}_{r} / {C}_{r}}}{{n}_{1}^{2} {R}_{eq\_B}}\end{matrix}$$

V₁: source voltage (forward mode)/load voltage (backward mode)
V₂: load voltage (forward mode)/source voltage (backward mode)
Lₘ₁: first transformer magnetizing inductance
Lₘ₂: second transformer magnetizing inductance
Lᵣ: resonant inductance
Cᵣ: resonant capacitance
1/n: rated converter forward voltage gain
n: rated converter backward voltage gain
n₁: first transformer turn ratio
n₂: second transformer turn ratio
f₀: resonant frequency
k: resonant inductance ratio
f: operation frequency
fₙ: normalized resonant frequency
R_{eq}: equivalent load resistance, forward mode (R_{eq_F}), backward mode (R_{eq_B})
Q: quality factor, forward mode (Q_{F}), backward mode (Q_{B})

We can see from the above equations that the forward and backward gain ranges of the proposed innovation are completely symmetric, and both of them are similar to the forward gain range of traditional LLC converters. As the LLC's forward gain range is typically wider than that of a CLLC converter, the 2T-LLC converter's forward and backward gain ranges are both wider than that of a CLLC converter.

What is more, the turn ratio of the additional transformer adds a degree of freedom to the design of the resonant parameters of the converter. When f₀, R_{eq}, and n are already determined by the converter's basic requirements, the values k and Q are also determined by converter's gain range requirements, and the resonant parameters, Lₘ₁, Lₘ₂, Lᵣ, Cᵣ, are still variable due to the additional degree of design freedom. According to actual needs, such as implementation difficulty, cost, etc., the resonant parameters can be designed to have appropriate values. This characteristic makes the present invention particularly suitable for bidirectional high voltage conversion ratio situations where traditional resonant converter topologies (LLC, CLLC, L3C) are not suitable. Consider the example, in forward mode, when the source voltage is 400V, load voltage is 40V, rated power is 3 kW, n=10, and f₀=100 kHz. The values k=4, Q_{F}=Q_{B}=0.4 are chosen to meet gain range requirements. By setting the first transformer turn ratio n₁=1, the second transformer turn ratio n₂=10, the final resonant parameters become Lₘ₁=Lₘ₂=110 uH, Lᵣ=27.5 uH and Cᵣ=92.1 nF. All of the resonant parameter values are proper and easy to be realized in practice. Consider another example, in forward mode, when the source voltage is 40V, load voltage is 400V, rated power is 3 kW, n=0.1 and f₀=100 kHz. The values k=4, Q_{F}=Q_{B}=0.4 are chosen to meet gain range requirements. By setting the first transformer turn ratio n₁=0.1, the second transformer turn ratio n₂=1, the final resonant parameters become Lₘ₁=Lₘ₂=110 uH, Lᵣ=27.5 uH and Cᵣ=92.1 nF. All of the resonant parameter values are proper and easy to be realized in practice.

From the above analysis, a conclusion that can be derived is that the proposed innovation has low power loss and high conversion efficiency. The forward and backward gain ranges of the proposed innovation are completely symmetric, and both of them are as wide as the forward gain range of a traditional LLC converter. So, the proposed innovation is capable of achieving a wide-range, bidirectional power conversion.

In a traditional LLC converter, the voltage of the resonant tank is dictated largely by the voltage of the source. However, the voltage of the resonant tank in the disclosed 2T-LLC converter can be deliberately set to be different from the source voltage by judicious selection of the turn ratio in the first transformer. The same applies for the second transformer for the reverse direction. The addition of the additional transformer adds a degree of freedom to the design of the resonant parameters of the converter, making the present invention particularly suitable for bidirectional high voltage conversion ratio situations where traditional resonant converter topologies are not suitable.

Note that the 2T-LLC converter becomes an equivalent circuit to the L3C converter when n₁=1, in that the input or source voltage Vᵢₙ becomes equal to the tank voltage Vₜₐₙₖ. Nevertheless, the source voltage and tank voltage remain electrically decoupled. In general, however, n₁ 1̅ and Vₜₐₙₖ V̅ᵢₙ.

FIG. 5 shows a schematic circuit of an example of the present invention for DC-to-DC conversion. The power is transferred from left-hand side to right-hand side. The first switch network 70 is a full-bridge inverter with four controlled switches. The switches can be MOSFET or IGBT devices with their embedded or external anti-parallel diodes. The second switch network 72 is a full-bridge synchronous rectifier with four switches; again the switches can be MOSFET or IGBT devices. The left-hand side of the first switch network is connected to a DC voltage source 74, which has a voltage value of V₁. The right-hand side of the second switch network is voltage load 76, which contains a parallel filter capacitor C_{L} and a load resistor R_{L}, the load voltage value being V₂.

Switches in the first switch network are turned on and off with an approximately 50% duty cycle and their switching frequency is controlled (e.g. by a processor), so that the full-bridge inverter produces a square-wave voltage with 50% duty cycle and variable frequency at its right-hand side. The first transformer 78 transfers the square-wave voltage to its right-hand side. The magnetizing inductor Lₘ₁ of the first transformer is effectively connected in parallel with the right-hand side of the first transformer 78. The magnetizing inductor Lₘ₂ of the second transformer 80 is effectively connected in parallel with the left-hand side of the second transformer. The series resonant inductor Lᵣ, magnetizing inductor Lₘ₂, and series resonant capacitor Cᵣ form an LLC resonant tank. The second transformer transfers the square-wave voltage to the second switch network 72, e.g. a full-bridge synchronous rectifier. In this example embodiment, the switches in the rectifier are controlled in a rectification manner with an approximately 50% duty cycle, so that they rectify the square-wave voltage to the load. The filter capacitor C_{L} filters out switching ripple, so the load voltage V₂ can remain stable.

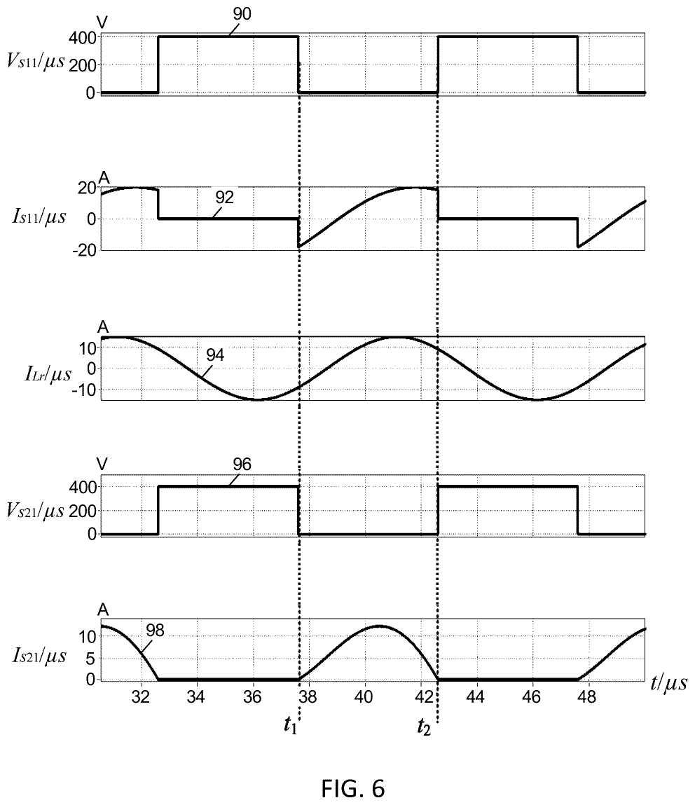

FIG. 6 shows the waveform 90 of the switch voltage V_{S11} and waveform 92 of the switch current I_{S11} of switch S₁₁. Also shown is the waveform 94 of the current I_{Lr} in the resonant tank, i.e. in the inductor Lᵣ. It also shows the waveform 96 of switch voltage V_{S21} and waveform 98 of switch current I_{S21} of S₂₁. The scales are volts, amps and μs. At the switching instances t₁ and t₂, at which one of the rectifier devices S₂₁ turns on and turns off respectively, the currents through S₂₁ are almost equal to zero, which effectively results in zero switching loss (i.e. ZCS). At the switching instance t₁, the current through one of the inverter switches S₁₁ is negative, i.e. it flows not through S₁₁ but through the anti-parallel diode for the switch. It follows that the voltage drop across the switch at these instances is very small and equal to the voltage drop across the junction of a forward biased diode, i.e. typically less than 1V. A very small switching loss (i.e. effectively ZVS) results.

In the case of power transfer from the right-hand side to left-hand side of the circuit shown in FIG. 5, the voltage source and the load swap their places, i.e. the load becomes a DC voltage source, while the DC voltage source becomes a load. In addition, the second switch network becomes a full-bridge inverter with controlled switching frequency and approximately 50% duty cycle width that produces a square-wave voltage with variable frequency. In addition, the first switch network becomes a full-bridge synchronously controlled rectifier with an approximately 50% duty cycle control pulse width that rectifies the square-wave voltage. The series resonant inductor Lᵣ, magnetizing inductor Lₘ₁, and series resonant capacitor Cᵣ form an LLC resonant tank. This change in the source, load, and the resonant tank can happen when the first switch network and the second switch network change their control functions from an inverter to a synchronous rectifier and vice versa. In this example embodiment, the inductance of magnetizing inductor Lₘ₁ equals that of magnetizing inductor Lₘ₂, which allows the bidirectional converter to have the same resonant configurations in both directions of power transfer.

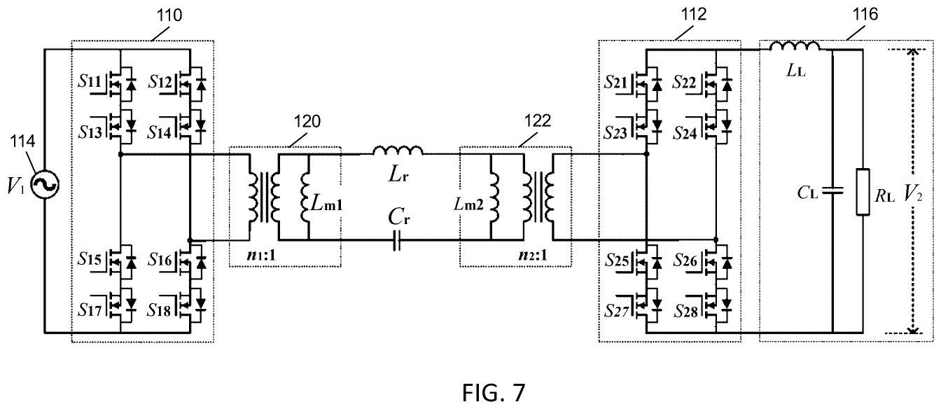

FIG. 7 shows a schematic circuit of an example of the present invention for AC-to-AC conversion. The power is transferred from the left-hand side to the right-hand side. The first switch network 110 is a matrix inverter, with eight controlled switches. More generally, the first switch network is a full-bridge converter with traditional or bidirectional switches. The switches can be MOSFET or IGBT devices with embedded or external anti-parallel diodes. Traditional switches include any full-bridge converter power switches. The second switch network 112 is a matrix rectifier, with eight switches, which can be MOSFET or IGBT devices. More generally, the second switch network is a full-bridge converter with traditional or bidirectional switches, or a matrix converter. The left-hand side of the first switch network is connected an AC voltage source 114, which has a voltage value of V₁. The right-hand side of the second switch network is connected an AC voltage load 116, which includes a series filter inductor L_{L}, a paralleled filter capacitor C_{L} and a load resistor R_{L}, the load voltage value being V₂. The AC-AC converter takes an input that is high voltage, low frequency AC and the output is low voltage, low frequency AC. High frequency AC is present in the resonant tank.

Switches in the first switch network 110 are operated according to the phase of the AC voltage source. During the negative half cycle of AC voltage source, in which the switches S₁₁, S₁₂, S₁₅, S₁₆ are always turned on, the switches S₁₃, S₁₄, S₁₇, S₁₈ are turned on and off with an approximately 50% duty cycle. The drive signals of Sis and S₁₇ are complementary, the drive signals of S₁₃ and S₁₈ are the same, and the drive signals of S₁₇ and S₁₄ are the same. Their switching frequency is controlled and is much higher than the AC voltage source frequency, for example by a factor of 10 to 100, or even higher. During the positive half cycle of the AC voltage source, the switches S₁₃, S₁₄, S₁₇, S₁₈ are always turned on and the switches S₁₁, S₁₂, S₁₅, S₁₆ are turned on and off in a similar fashion, like S₁₃, S₁₄, S₁₇, S₁₈ in the negative half cycle. So, the first switch network 110 converts the AC voltage to a square-wave voltage with a 50% duty cycle, spindle-shaped envelope and a variable frequency at its right-hand side. The first transformer 120 transfers the square-wave voltage to its right-hand side. The series resonant inductor Lᵣ, magnetizing inductor Lₘ₂, and series resonant capacitor Gr form an LLC resonant tank. The second transformer 122 transfers the square-wave voltage to the second switch network 112, a matrix rectifier. In this example embodiment, the switches in the matrix rectifier are controlled in a rectification manner with an approximately 50% duty cycle, and their switching frequency is the same as that of the AC voltage source, so that they rectify the spindle-shaped square-wave voltage to the load 116. The filter inductor and capacitor filter out switching ripple, so the load voltage V₂ has the same shape and frequency as the AC voltage source.

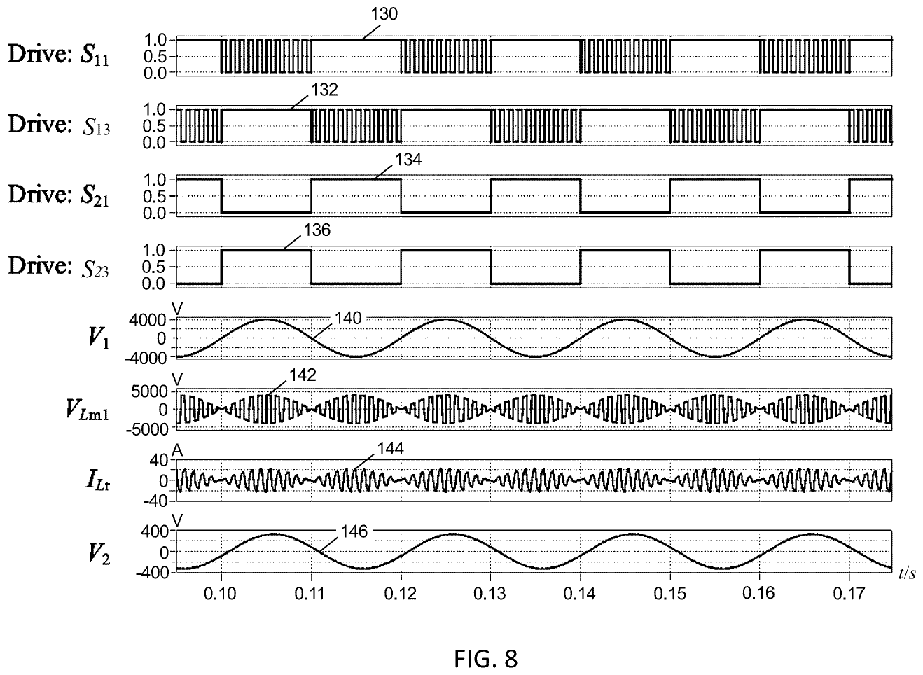

FIG. 8 shows, for the circuit of FIG. 7, the waveforms 130, 132, 134, 136 of the switch drive signals for S₁₁, S₁₃, S₂₁, S₂₃ respectively. It also shows the middle stage voltage 142 and current 144 where V_{Lm1} is the voltage on inductor Lₘ₁ and I_{Lr} is the current through inductor Lᵣ. The waveforms 140, 146 of the source voltage V₁ and load voltage V₂ respectively are also shown. The AC voltage source frequency is 50 Hz and the switching frequency of the switch in the first switch network is 1 kHz. So, the voltage on inductor Lₘ₁ is a 1 kHz square-wave and has a 100 Hz envelope, which is twice the AC voltage source frequency. The LLC resonant tank can enable ZVS on the first switch network and ZCS on the second switch network. The load voltage V₂ has the same shape and frequency as the AC voltage source, but its amplitude is changed by the turn ratio setting of the two transformers, which demonstrates that the proposed invention can achieve reliable AC-AC conversion.

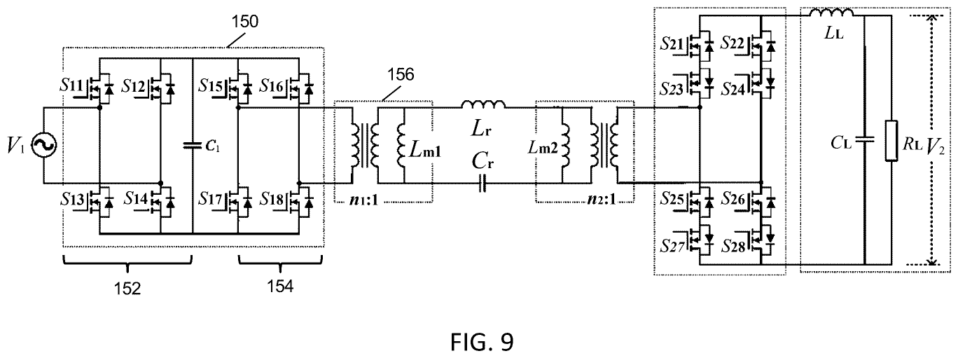

FIG. 9 shows a schematic circuit of another example of the present invention for AC-to-AC conversion. The power is transferred from the left-hand side to the right-hand side. The difference between FIG. 7 and FIG. 9 is that the first switch network 150 in FIG. 9 is a two-stage circuit rather a one-stage inverter; it has a full-bridge rectifier 152 or active rectifier followed by a parallel capacitor and a full-bridge inverter 154. The full-bridge rectifier and full-bridge inverter both include four switches with embedded or external anti-parallel diodes. The other part of FIG. 9 is the same as FIG. 7.

The full-bridge rectifier 152 in the first switch network 150 is operated and controlled in a synchronous rectification manner, so it rectifies the AC source voltage into a varying DC voltage with twice the AC source frequency envelope. The full-bridge inverter 154 in the first switch network 150 is turned on and off with an approximately 50% duty cycle and its switching frequency is controlled, so that the full-bridge inverter produces a spindle-shaped square-wave voltage with a 50% duty cycle and variable frequency at its right-hand side. The first transformer 156 transfers the spindle-envelope square-wave voltage to its right-hand side. The subsequent operating principle of the circuit in FIG. 9 is the same as that in FIG. 7.

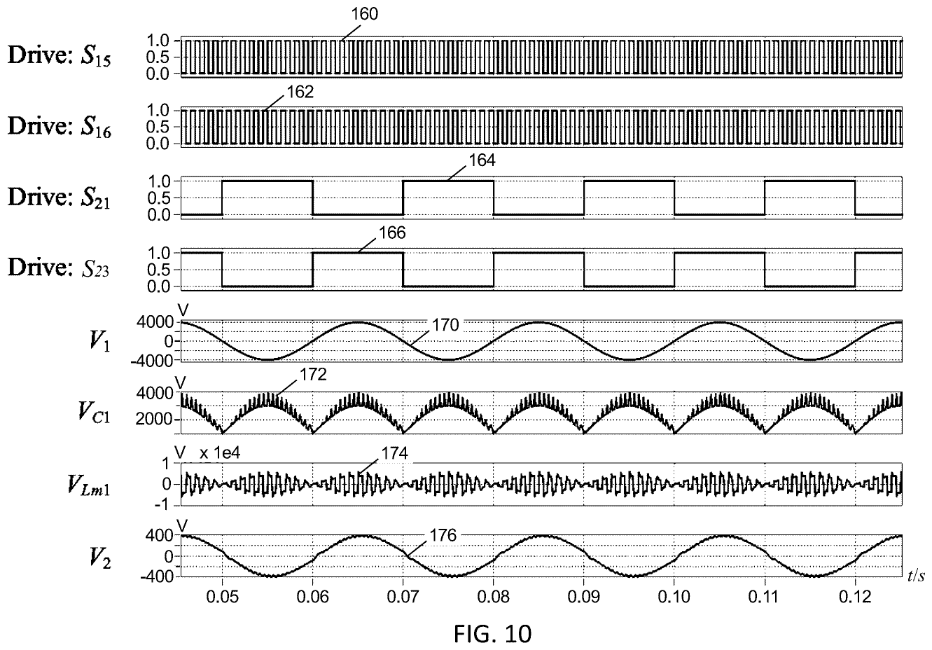

FIG. 10 shows, for the circuit in FIG. 9, the waveforms 160, 162, 164, 166 of the switch drive signals for S₁₅, S₁₆, S₂₁, S₂₃ respectively. It also shows the waveforms 170, 172, 174, 176 for respectively the source voltage V₁, the voltage V_{C1} on capacitor C₁, the voltage V_{Lm1} across the output side of first transformer 156 and the load voltage V₂. The AC voltage source frequency is 50 Hz, the switching frequency of the switch in the full-bridge is 1 kHz. So, the voltage on capacitor C₁ is a DC voltage and has a 100 Hz envelope, which is twice the AC voltage source frequency. The voltage on inductor Lₘ₁ is a 1 kHz square-wave and also has an envelope of 100 Hz, which is twice the AC voltage source frequency. The LLC resonant tank can enable ZVS on the first switch network and ZCS on the second switch network. The load voltage V₂ has the same shape and frequency as the AC voltage source, but its amplitude is changed by the turn ratio setting of the two transformers.

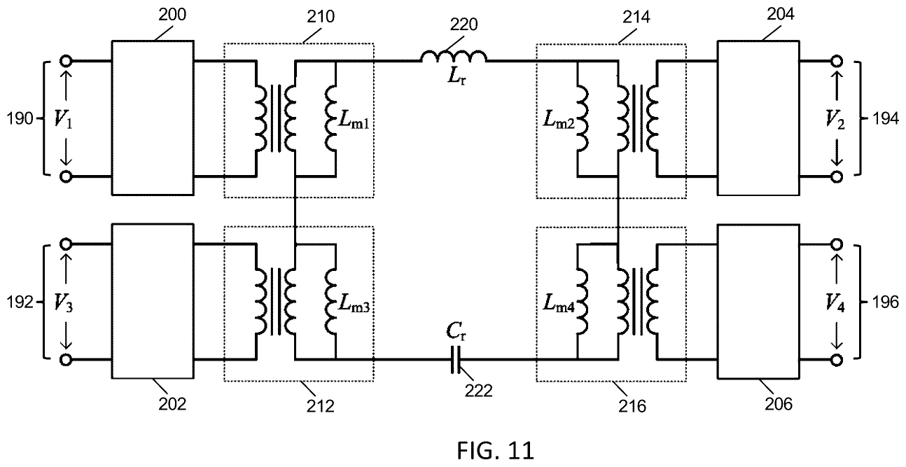

The above-mentioned embodiments are all two-port topologies, with bidirectional energy transmission between the two ports. The invention can further be extended to a multiport type topology as shown in FIG. 11. The topology in FIG. 11 has four ports 190, 192, 194, 196, and each port has a switch network 200, 202, 204, 206 respectively and a transformer 210, 212, 214, 216 respectively. One side of each switch network is connected to one side of the related transformer, and another side of each switch network is connected to a voltage source or voltage load. The other side of each transformer is connected in series with a resonant inductor 220 and a resonant capacitor 222. Inputs and outputs may be balanced or unbalanced. The resonant tank may be considered to be a high-frequency AC bus.

The loads and/or sources connected to the multiport converter include ESSs, electric vehicles, an electricity grid and renewable energy sources, for example. Such a multiport topology can reduce the number of power stages that would otherwise be required, can handle high power densities and can lead to a lower cost. Transformers provide electrical isolation for each port, and the resonant tank provides for soft switching conditions for each switch.

Each port can act as energy source or load, and power can be transmitted bidirectionally between any two or more ports. Due to the fact that this multiport topology still has a completely symmetrical structure, the advantages of the two-port topologies mentioned earlier are still valid in this multiport topology. For example, one of the ports is connected to a source, while the other three ports are each connected to a different load. As another example, any two of the ports are each connected to a different source and the other two ports are connected to two different loads. In another example, one of the ports is connected to a load and the other three ports are each connected to a different source. In some arrangements, one or two of the ports are unconnected to a source or load, in which case the port-side of the corresponding transformer is short-circuited by the corresponding switch network. This may be achieved by switching on either the two upper switches or the two lower switches in an H-bridge switch network (see FIG. 7). Note that there may be some conduction losses introduced, however this will assist fault-tolerant operation.

FIG. 12 shows a specific example of 5-port 2T-LLC converter, where 3 ports are connected to voltage sources V₁, V₂, V₃, respectively, by full-bridge inverters, and two ports are connected to loads by full-bridge rectifiers, the load voltages being V₄, V₅, respectively.

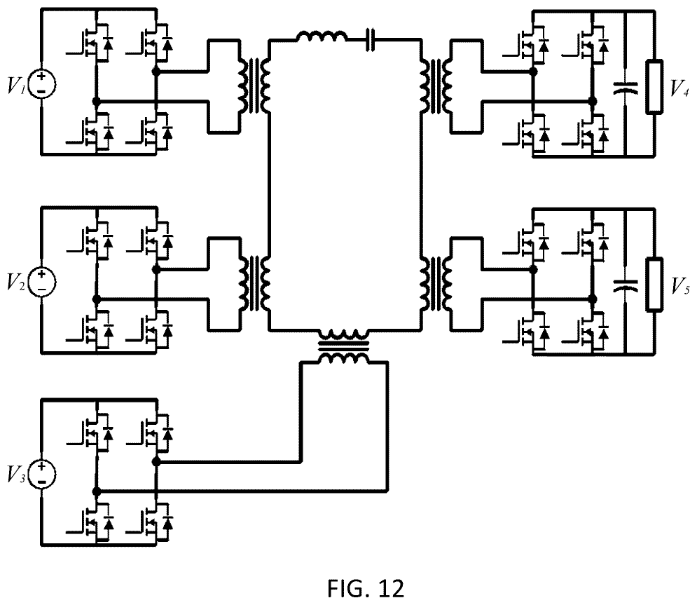

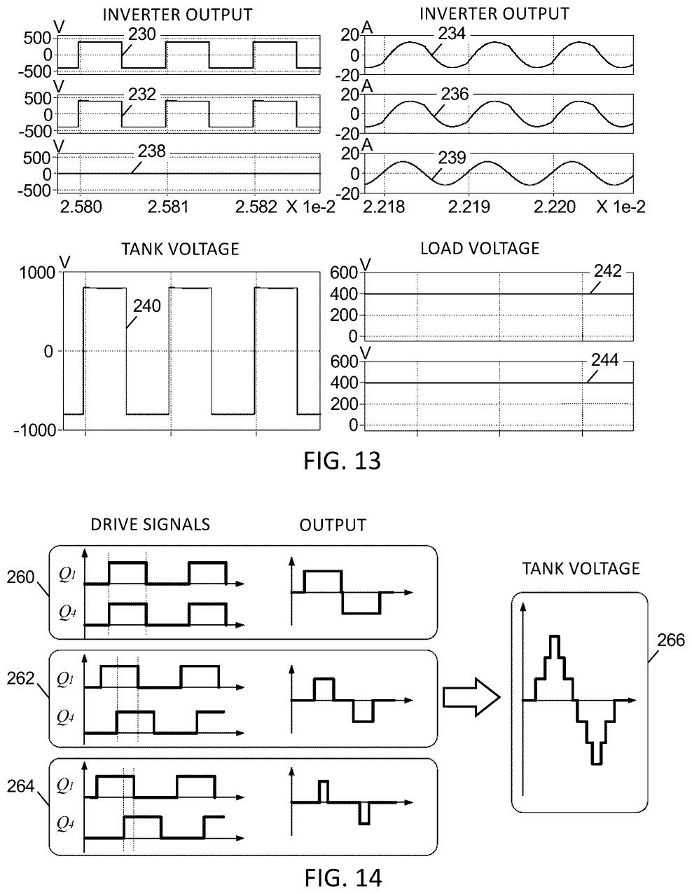

FIG. 13 shows the results from a simulator of a 5-port 2T-LLC converter. The resonant frequency f₀ is 100 kHz, Lᵣ=27.5 uH, and Cᵣ=92.1 nF. The magnetizing inductance of each transformer is set to 110 uH, and R_{L1}=R_{L2}=53.3Ω. Two of the source ports are used as inputs, each at 400V, 3 kW, with inverter output voltage waveforms 230, 232, and output current waveforms 234, 236. The rest source port is short-circuited, with a zero voltage waveform 238. The waveform 239 is the short-circuited port current, corresponding to voltage 238. In this condition, this port is short-circuited by bypassing the upper or lower two switches in the full bridge, so that the output voltage is zero. The short-circuited current through these two switches, and the current waveform are the same as the waveforms 234 and 236. Two load ports are used as 400V, 3 kW outputs. The resonant tank voltage has waveform 240. The voltages at the loads have waveforms 242, 244.

FIG. 14 shows drive signals for source-side phase shift modulation when three of the ports 260, 262, 264 of the 5-port converter are connected to sources. The drive signals for each switching network have a different phase shift, resulting in different outputs. The modulation is achieved by cascading the H-bridges. The resonant tank voltage 266 is determined by the source side phase shift and is a superposition of the outputs of the transformers corresponding to the connected sources. Similarly, the output power distribution is controlled by the load side phase shift, if implemented. The equivalent load resistances are adjusted by rectifier phase shift angles.

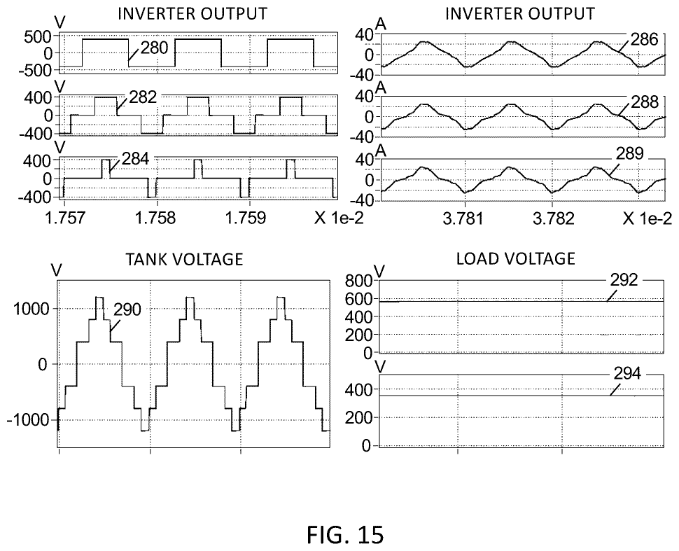

FIG. 15 shows the results from a simulator of a 5-port 2T-LLC converter. The resonant frequency f₀ is 100 kHz, Lᵣ=27.5 uH, and Cᵣ=92.1 nF. The magnetizing inductance of each transformer is set to 110 uH, and R_{L1}=R_{L2}=53.3Ω. Three of the ports are used as inputs: one at 400V, 4.2 kW, one at 400V, 3 kW and one at 400V, 1.2 kW, with inverter output voltage waveforms 280, 282, 284 respectively, and inverter output current waveforms 286, 288, 289 respectively. The other two ports are used as outputs: one at 565V, 6 kW and one at 353V, 2.4 kW. The resonant tank voltage 290 tracks a combination of the three inverter output voltages for the three sources. The voltages at the loads have waveforms 292, 294.

The multiport 2T-LLC converter may also be used as a multi-port AC-AC converter.

The windings of the two transformers may be wound on a common magnetic assembly, such as an integrated magnetic assembly formed from two or more individual magnetic cores.

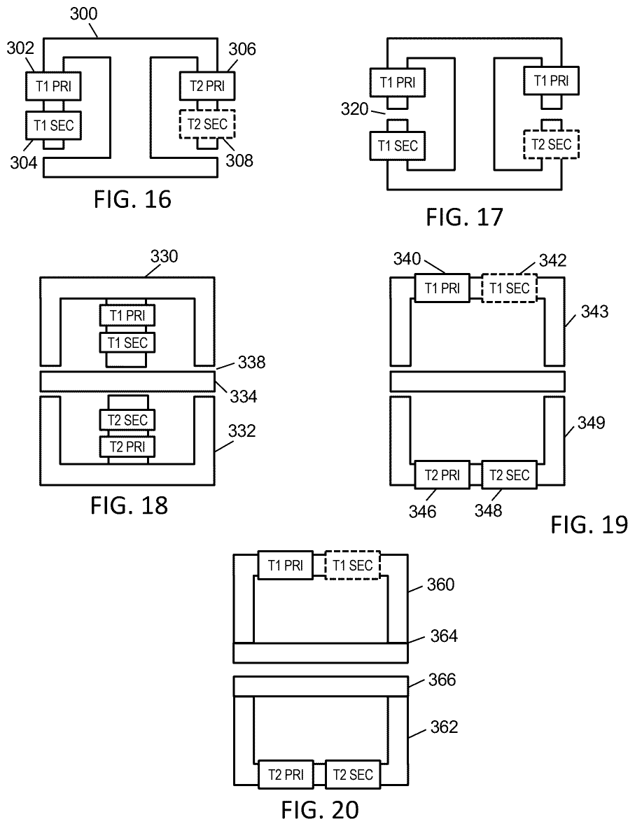

FIG. 16 is an example of transformer architecture in which the two transformers of a 2T-LLC converter are formed using an integral magnetic block 300 with an E-core and an I-core. Flux cancellation is used to reduce the necessary core size. The first transformer has its primary (port-side) 302 and secondary (tank-side) 304 windings on an outer arm of the E-core. The second transformer has primary (port-side) 306 and secondary (tank-side) 308 windings on the other outer arm of the E-core. The secondary winding 308 of the second transformer is in a reverse direction compared to the other three windings 302, 304, 306. The I-core is connected to the middle arm of the E-core, and there are air gaps between the outer arms of the E-core and the I-core.

FIG. 17 is an alternate transformer architecture that uses two E-cores that are connected at the ends of their middle arms. The main difference is that the air gaps 320 are in a different location.

FIG. 18 is another transformer architecture, which uses two E-cores 330, 332 and an I-core 334. Each transformer is wound around the middle arm of a different E-core, and the E-cores are separated from the I-core by air gaps 338.

FIG. 19 is another transformer architecture, which uses two U-cores and an I-core. The first transformer has its primary (port-side) 340 and secondary (tank-side) 342 windings on the middle of one U-core 343. The second transformer has primary (port-side) 346 and secondary (tank-side) 348 windings on the middle of the other U-core 349. The secondary winding 342 of the first transformer is in a reverse direction compared to the other three windings 340, 346, 348.

FIG. 20 is another transformer architecture, which uses two U-cores 360, 362 and two I-cores 364, 366. Each transformer is wound around the middle of a different U-core, and the transformers and their cores are separated.

### C. Comparisons

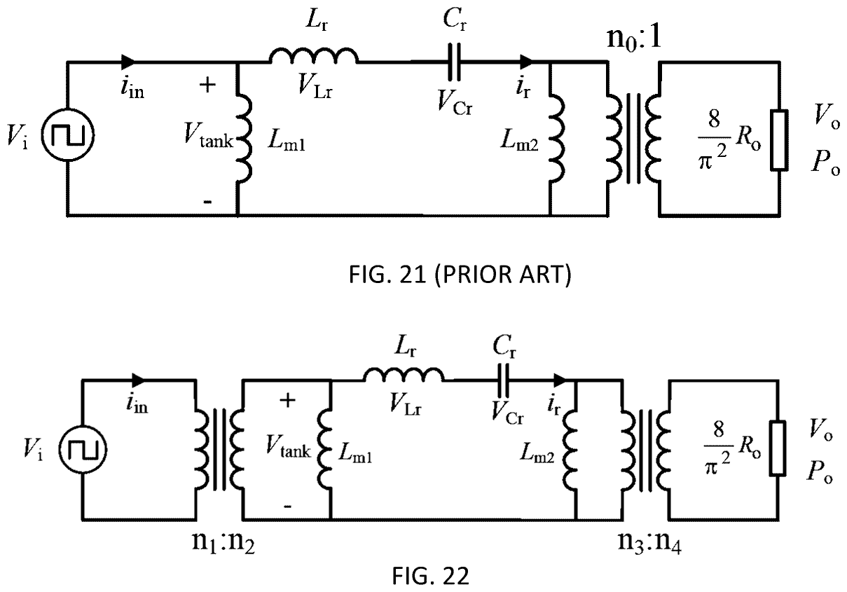

Referring to FIG. 21, a prior L3C converter is shown. TABLE 1 shows example component and parameter values for the converter to have a low input voltage and high output power, with resonant frequency f₀=100 kHz.

TABLE 1

| Parameter | Symbol | Value | |
|---|---|---|---|
| Input voltage | Vᵢ | 40 | V |
| Output voltage | Vₒ | 40 | V |
| Output power | Pₒ | 3000 | W |
| Resonant frequency | f₀ | 100 | kHz |
| Turn ratio | n₀ | 1 | |
| Current stress | iᵣ | 105 | A |
| Voltage stress | V_{Lr} V_{Cr} | 18.2 | V |
| Resonant inductor | Lᵣ | 0.275 | μH |
| Magnetizing inductor | Lₘ₂ | 1.1 | μH |
| Resonant capacitor | Cᵣ | 9210 | nF |

As can be seen, the current stress is too large, the resonant and magnetizing inductors are too small and hard to realize, and the resonant capacitor is too large and inconvenient to realize. For example, the resonant capacitor would need to be made from 28 film capacitors of 330 nF each.

Referring to FIG. 22, a 2T-LLC converter is shown. TABLE 2 shows example component and parameter values for the converter to have a low input voltage and high output power.

TABLE 2

| Parameter | Symbol | Value | |
|---|---|---|---|
| Input voltage | Vᵢ | 40 | V |
| Output voltage | Vₒ | 40 | V |
| Output power | Pₒ | 3000 | W |
| Resonant frequency | f₀ | 100 | kHz |
| Turn ratio | n₁:n₂ | 1:10 | |
| Turn ratio | n₃:n₄ | 10:1 | |
| Current stress | iᵣ | 10.5 | A |
| Voltage stress | V_{Lr} V_{Cr} | 182 | V |
| Resonant inductor | Lᵣ | 27.5 | μH |
| Magnetizing inductor | Lₘ₂ | 110 | μH |
| Resonant capacitor | Cᵣ | 92.1 | nF |

As can be seen, the values are more manageable. For example, the resonant capacitor could be made from 6 film capacitors of 15 nF each plus 1 film capacitor of 2.1 nF.

Referring back to FIG. 21, TABLE 3 shows example component and parameter values for the L3C converter to have a high input voltage and low output power. As can be seen, the resonant and magnetizing inductors are too large, and the resonant capacitor is too small.

TABLE 3

| Parameter | Symbol | Value | |
|---|---|---|---|
| Input voltage | Vᵢ | 400 | V |
| Output voltage | Vₒ | 40 | V |
| Output power | Pₒ | 100 | W |
| Resonant frequency | f₀ | 100 | kHz |
| Turn ratio | n₀ | 10 | |
| Current stress | iᵣ | 0.35 | A |
| Voltage stress | V_{Lr} V_{Cr} | 182 | V |
| Resonant inductor | Lᵣ | 825 | μH |
| Magnetizing inductor | Lₘ₂ | 3300 | μH |
| Resonant capacitor | Cᵣ | 3.07 | nF |

Referring back to FIG. 22, TABLE 4 shows example component and parameter values for the 2T-LLC converter to have a high input voltage and low output power.

TABLE 4

| Parameter | Symbol | Value | |
|---|---|---|---|
| Input voltage | Vᵢ | 400 | V |
| Output voltage | Vₒ | 40 | V |
| Output power | Pₒ | 100 | W |
| Resonant frequency | f₀ | 100 | kHz |
| Turn ratio | n₁:n₂ | 5:1 | |
| Turn ratio | n₃:n₄ | 2:1 | |
| Current stress | iᵣ | 1.75 | A |
| Voltage stress | V_{Lr} V_{Cr} | 36.4 | V |
| Resonant inductor | Lᵣ | 33 | μH |
| Magnetizing inductor | Lₘ₂ | 132 | μH |
| Resonant capacitor | Cᵣ | 76.75 | nF |

As can be seen, the resonant and magnetizing inductors and the resonant capacitor have practical values.

Referring back to FIG. 21, TABLE 5 shows example component and parameter values for different input voltages to the L3C converter for a 40V, 3000 W output.

TABLE 5

| Parameter | Symbol | Value | | Value | | Value | | Value | |
|---|---|---|---|---|---|---|---|---|---|
| Input voltage | Vᵢ | 400 | V | 200 | V | 100 | V | 40 | V |
| Turn ratio | n₀ | 10 | | 5 | | 2.5 | | 1 | |
| Current stress | iᵣ | 10.5 | A | 21 | A | 42 | A | 105 | A |
| Voltage stress | V_{Lr} V_{Cr} | 182 | V | 91 | V | 40.5 | V | 18.2 | V |
| Resonant | Lᵣ | 27.5 | μH | 6.88 | μH | 1.72 | μH | 0.275 | μH |
| inductor | | | | | | | | | |
| Magnetizing | Lₘ₁ Lₘ₂ | 110 | μH | 27.5 | μH | 6.88 | μH | 1.1 | μH |
| inductors | | | | | | | | | |
| Resonant | Cᵣ | 92.1 | nF | 368.4 | nF | 1474 | nF | 9210 | nF |
| capacitor | | | | | | | | | |

As can be seen, while the turn ratio needs to be varied, the component values and tank parameters show significant variations for the different input voltages.

Referring back to FIG. 22, TABLE 6 shows example component and parameter values for different input voltages to the 2T-LLC converter for a 40V, 3000 W output.

TABLE 6

| Parameter | Symbol | Value | | Value | | Value | | Value | |
|---|---|---|---|---|---|---|---|---|---|
| Input voltage | Vᵢ | 400 | V | 200 | V | 100 | V | 40 | V |
| Turn ratio | n₁:n₂ | 1:1 | | 1:2 | | 1:4 | | 1:10 | |
| Turn ratio | n₃:n₄ | 10:1 | | 10:1 | | 10:1 | | 10:1 | |
| Current stress | iᵣ | 10.5 | A | 10.5 | A | 10.5 | A | 10.5 | A |
| Voltage stress | V_{Lr} V_{Cr} | 182 | V | 182 | V | 182 | V | 182 | V |
| Resonant | Lᵣ | 27.5 | μH | 27.5 | μH | 27.5 | μH | 27.5 | μH |
| inductor | | | | | | | | | |
| Magnetizing | Lₘ₁ Lₘ₂ | 110 | μH | 110 | μH | 110 | μH | 110 | μH |
| inductors | | | | | | | | | |
| Resonant | Cᵣ | 92.1 | nF | 92.1 | nF | 92.1 | nF | 92.1 | nF |
| capacitor | | | | | | | | | |

As can be seen, while the turn ratio needs to be varied, the component values and tank parameters remain constant for the different input voltages.

Using common circuit analysis techniques, it is possible to evaluate the optimum tank voltage, and therefore input voltage, for an L3C converter for different output powers. The optimum tank voltage will be dictated at least in part by the practicality of component values. The transformer turn ratio will be dependent on the required output voltage. TABLE 7 shows parameter and component values for output powers between 3 kW and 30 kW. The voltages shown for each output power are those between which the parameters and component values are practical. Outside of these voltages, one or more of the parameters and/or component values become impractical. Reasons for this impracticality include parasitic capacitance caused by a large number of transformer or inductor turns, large capacitor volume and cost, or too small an inductance to be realized.

TABLE 7

| P₀ | Vᵢ | iᵣ | | V_{Lr} V_{Cr} | Lᵣ | | Lₘ₁ Lₘ₂ | | Cᵣ | |
|---|---|---|---|---|---|---|---|---|---|---|
| 3 kW | 400 V | 10.5 | A | 182 V | 27.5 | μH | 110 | μH | 92.1 | nF |
| 3 kW | 600 V | 7.0 | A | 273 V | 61.9 | μH | 248 | μH | 40.9 | nF |
| 5 kW | 600 V | 11.7 | A | 273 V | 37.1 | μH | 148 | μH | 68.1 | nF |
| 5 kW | 800 V | 8.76 | A | 364 V | 66 | μH | 260 | μH | 38.3 | nF |
| 10 kW | 600 V | 23.4 | A | 273 V | 18.5 | μH | 74 | μH | 136.4 | nF |
| 10 kW | 800 V | 17.5 | A | 364 V | 33 | μH | 130 | μH | 76.8 | nF |
| 20 kW | 800 V | 35 | A | 364 V | 16.5 | μH | 65 | μH | 154 | nF |
| 20 kW | 1000 V | 28 | A | 455 V | 25.8 | μH | 103 | μH | 98 | nF |
| 30 kW | 800 V | 53 | A | 364 V | 11 | μH | 44 | μH | 230 | nF |
| 30 kW | 1000 V | 42 | A | 455 V | 17.2 | μH | 68.8 | μH | 147 | nF |

In comparison to the above, TABLE 8 shows parameter and component values for output powers between 3 kW and 30 kW for a 2T-LLC converter. The second transformer turn ratio will be dependent on the required output voltage. It can be seen that a greater range of input voltages are possible for each output power level, while retaining practical values of components and parameters.

TABLE 8

| | | | | | V_{Lr} | | Lₘ₁ | |
|---|---|---|---|---|---|---|---|---|
| P₀ | Vᵢ | n₁:n₂ | Vₜₐₙₖ | iᵣ | V_{Cr} | Lᵣ | Lₘ₂ | Cᵣ |
| 3 kW | 200-1000 V | 1:2-5:2 | 400 V | 10.5 A | 182 V | 27.5 μH | 110 μH | 92.1 nF |
| 5 kW | 200-1000 V | 1:3-5:3 | 600 V | 11.7 A | 273 V | 37.1 μH | 148 μH | 68.1 nF |
| 10 kW | 200-1000 V | 1:4-5:4 | 800 V | 17.5 A | 364 V | 33 μH | 130 μH | 76.8 nF |
| 20 kW | 200-1000 V | 1:5-5:5 | 1000 V | 28 A | 455 V | 25.8 μH | 103 μH | 98 nF |
| 30 kW | 200-1000 V | 1:5-5:5 | 1000 V | 42 A | 455 V | 17.2 μH | 68.8 μH | 147 nF |

In other examples, the turn ratio could be chosen so that the same component values are used for all power outputs. TABLE 9 shows what the tank voltages are, while using Lᵣ=27.5 μH, Lₘ₁=Lₘ₂=110 μH, and Cᵣ=92.1 nF. Again, the transformer turn ratios are selected depending on the input and output voltages.

TABLE 9

| | | | | V_{Lr} |
|---|---|---|---|---|
| P₀ | Vₜₐₙₖ | | iᵣ | V_{Cr} |
| 3 kW | 400 | V | 10.5 A | 182 V |
| 5 kW | 516.4 | V | 13.55 A | 235 V |
| 10 kW | 730.3 | V | 19.17 A | 332 V |
| 20 kW | 1032.8 | V | 27.13 A | 470 V |
| 30 kW | 1264.9 | V | 33.2 A | 575 V |

If a CLLC converter is designed with symmetric resonant parameters, then the resonant parameters for the secondary tank will vary depending on the output voltage. For output voltages that are significantly lower than the input voltage, e.g. V₀=40-100V, Vᵢ=400V, then the values of the resonant capacitor and inductor in the secondary resonant tank become impractical to realize because they are too high or low respectively. For input voltages that are significantly lower than the output voltage, e.g. Vᵢ=40-100V, V₀=400V, then the values of the resonant capacitor and inductor in the primary resonant tank become impractical to realize because they are too high or low respectively. If a CLLC converter designed for high power is operated at low power, then the choice of resonant parameters is narrow if a wide gain range is sought. However, a wider range of resonant parameters is available if a narrow gain range is acceptable. For example, a 30 kW CLLC converter may have a gain range of 0.67-1.35, but if it is operated at 3 kW, the gain range becomes 0.85-1.43, i.e. limited below unity. Conversely, a 3 kW CLLC converter may have a gain range of 0.67-1.35, but if it is operated at 30 kW, the gain range becomes 0.13-1, being limited above unity.

For an L3C converter, the resonant tank parameters depend on the input voltage. For input voltages that are significantly lower than the output voltage, e.g. Vᵢ=40-100V, V₀=400V, then the values of the magnetizing and resonant inductors become impractical to realize because they are too low. Also, the value of the resonant capacitor becomes impractical to realize because it is too high. However, the resonant tank parameters do not depend on the output voltage and can be practically realized for a relatively wide range of output voltages.

In contrast, the resonant tank parameters in a 2T-LLC converter do not need to be tailored to different input or output voltages. The same resonant tank may therefore be used for relatively wide ranges of both input and output voltages, e.g. 40-400V for both. In terms of proper resonant parameters, there is substantially no voltage restriction for a 2T-LLC converter, a restriction of input voltage range for an L3C converter, and a restriction of both the input and output voltage ranges for a CLLC converter.

### D. AC/DC Conversion

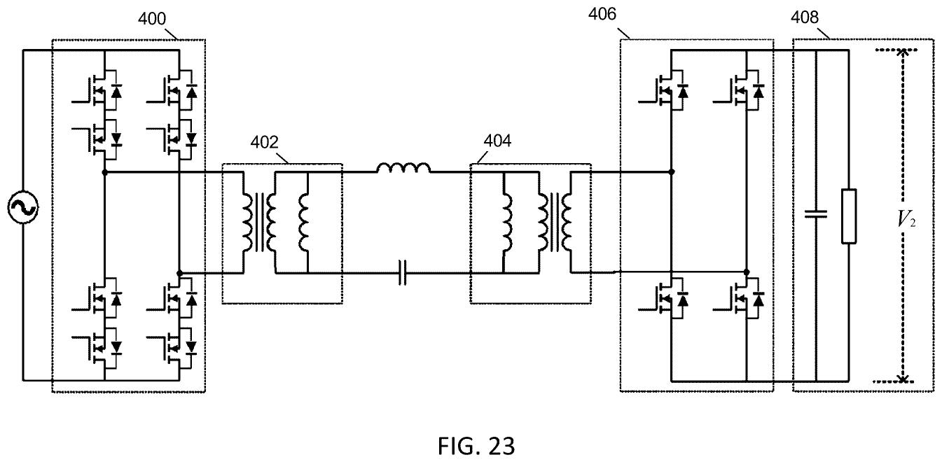

FIG. 23 is a schematic circuit of an example of the present invention for AC-to-DC conversion. The power is transferred from the left-hand side to the right-hand side. The difference between FIG. 7 and this figure is that the second switch network 406 in this figure is a full-bridge rectifier rather than a matrix rectifier. The first switch network 400 operates in the same manner as that in FIG. 7, converting the AC voltage to a square-wave voltage with a 50% duty cycle, spindle-shaped envelope and a variable frequency at its right-hand side. The first transformer 402 transfers the square-wave voltage to its right-hand side. The series resonant inductor Lᵣ, magnetizing inductor Lₘ₂, and series resonant capacitor Cᵣ form an LLC resonant tank. The second transformer 404 transfers the square-wave voltage to the second switch network 406, a full-bridge rectifier. In this example embodiment, the switches in the full-bridge rectifier are controlled in an uncontrolled rectification manner or a synchronous rectification manner, so that they rectify the spindle-shaped square-wave voltage to DC voltage. The capacitor filters out switching ripple, and a stable DC voltage V₂ is obtained for load 408. This circuit can of course be operated in the reverse direction to convert DC to AC.

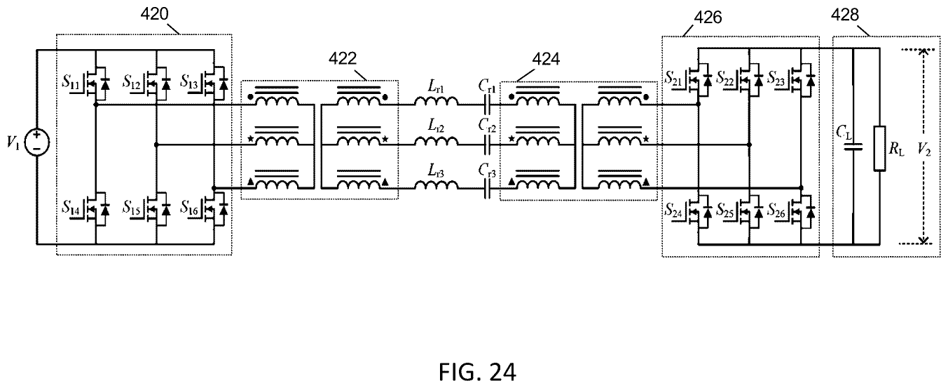

FIG. 24 shows a schematic circuit of another example of the present invention for DC-to-DC conversion. The difference between FIG. 5 and this figure is that FIG. 5 is single-phase full-bridge structure, while this figure is three-phase full-bridge structure. Three-phase structures can handle much higher power compared to half-bridge and full-bridge structures.

When the power is transferred from the left-hand side to the right-hand side, the first switch network 420 is a three-phase full-bridge inverter with six controlled switches. The switches are MOSFET or IGBT devices with their embedded or external anti-parallel diodes. The second switch network 426 is a three-phase full-bridge synchronous rectifier with six switches; again the switches are MOSFET or IGBT devices. The first transformer 422 and the second transformer 424 are both six-winding transformers with three pairs of coupled windings, and can also be considered as three independent two-winding transformers. It should be noted that the magnetizing inductors of the first transformer and the second transformer are not shown in figure, but they exist, and it can be considered that each right-hand side winding of the first transformer is effectively connected with a magnetizing inductor in parallel, and each left-hand side winding of the second transformer is effectively connected with a magnetizing inductor in parallel.

The left-hand side of the first switch network is connected to a DC voltage source, which has a voltage value of V₁. The right-hand side of the first switch network is connected to three left-hand side windings of the first transformer. Each right-hand side winding of the first transformer is connected in series with a resonant capacitor, a resonant inductor, and one of the left-hand side windings of the second transformer. The right-hand side of the second transformer is connected to the left-hand side of the second switch network. The right-hand side of the second switch network is connected to a DC load 428, which contains a parallel filter capacitor C_{L} and a load resistor R_{L}, the load voltage value being V₂

Switches in the first switch network are turned on and off with an approximately 50% duty cycle, their switching frequency is controlled (e.g. by a processor), and the three switching legs are phase shifted by 120 degrees. In this situation, the three-phase full-bridge inverter produces a three-phase square-wave voltage with 50% duty cycle and variable frequency at its right-hand side. The first transformer transfers the three-phase square-wave voltage to its right-hand side. Each magnetizing inductor of the left-hand side winding of second transformer, along with its series resonant inductor, and series resonant capacitor Cᵣ form an LLC resonant tank; in total three LLC resonant tanks are formed. The second transformer transfers the three-phase square-wave voltage to the second switch network, e.g. a three-phase full-bridge synchronous rectifier, which rectifies the three-phase square-wave voltage to the load. The filter capacitor C_{L} filters out switching ripple, so the load voltage V₂ can remain stable.

In the case of power transfer from the right-hand side to left-hand side of the circuit shown in FIG. 24, the voltage source and the load swap their places, i.e. the load becomes a DC voltage source, while the DC voltage source becomes a load. In addition, the second switch network becomes a three-phase full-bridge inverter that produces a three-phase square-wave voltage with variable frequency. In addition, the first switch network becomes a three-phase full-bridge synchronously controlled rectifier that rectifies the three-phase square-wave voltage. Each magnetizing inductor of the right-hand side winding of the first transformer, along with its series resonant inductor, and series resonant capacitor Cᵣ form an LLC resonant tank; in total three LLC resonant tanks are again formed. This change in the source, load, and the resonant tank can occur when the first switch network and the second switch network change their control functions from an inverter to a synchronous rectifier and vice versa.

### E. Variations

It will be clear to one having skill in the art that further variations to the specific details disclosed herein can be made, resulting in other embodiments that are within the scope of the invention disclosed.

Where MOSFET or IGBT devices have been described, these may be replaced with other voltage-controlled power switching devices in other embodiments. Example devices include: GaN FET (Gallium Nitride Field-Effect), SiC MOSFET (Silicon Carbide Metal-Oxide-Semiconductor Field-Effect Transistor), MCT (Metal-Oxide-Semiconductor-Controlled Thyristor), VMOS (V-Groove Metal-Oxide Semiconductor), JFET (Junction Field-Effect Transistor), E-MOSFET (Enhancement-mode Metal-Oxide-Semiconductor Field-Effect Transistor) and D-MOSFET (Depletion-mode Metal-Oxide-Semiconductor Field-Effect Transistor).

In some embodiments the converter may include current-controlled switches such as a BJT (Bipolar Junction Transistor), SCR (Silicon Controlled Rectifier) or Thyristor, GTO (Gate Turn-Off Thyristor), Triac (Triode for Alternating Current), UJT (Uni-Junction Transistor), PUT (Programmable Uni-Junction Transistor), SCS (Silicon Controlled Switch), MJT (Monolithic Junction Transistor), LED (Light Emitting Diode) and IGCT (Integrated Gate-Commutated Thyristor).

In some embodiments, different kinds of converter may be used, for example multilevel converters such as a Diode-Clamped Multilevel Converter (DCMC), Flying Capacitor Multilevel Converter (FCMC), Cascaded H-Bridge Multilevel Converter (CHB), Modular Multilevel Converter (MMC), Neutral Point Clamped Converter (NPC), Active Neutral Point Clamped Converter (ANPC), Hybrid Multilevel Converter, Reduced Device Count Multilevel Converter, T-Type Multilevel Converter, or Packed U-Cell Converter (PUC).

In some embodiments, the resonant inductor and capacitor may be alongside each other in the same loop of the circuit.

Embodiments, depending on their configuration, may exhibit all or fewer than all of the advantages described herein. Other advantages not mentioned may be present in one or more of the embodiments.

Features from any of the embodiments may be combined with features from any of the other embodiments to form another embodiment within the scope of the invention.

Numbers and percentages are specified to the nearest significant digit. Numerical values inherently include an expected tolerance, e.g. 10% or to one significant digit, unless specified as exact. All ranges given include all subranges within the range. For example, if a range is given as m-q, then the ranges m-n, n-p and p-q are included, where n and p are any values that satisfy m<n<p<q. In general, unless otherwise indicated, singular elements may be in the plural and vice versa with no loss of generality. All parameters, quantities and configurations described herein are examples only and may be changed depending on the specific embodiment implemented.

Throughout the description, specific details have been set forth in order to provide a more thorough understanding of embodiments of the invention. However, the invention may be practised without these specific details. In other instances, well known elements have not been shown or described in detail and repetitions of steps and features have been omitted to avoid unnecessarily obscuring the invention. Accordingly, the specification and drawings are to be regarded in an illustrative, rather than a restrictive, sense. It will be clear to one having skill in the art that variations to the details disclosed herein can be made, resulting in other embodiments that are within the scope of the invention disclosed. Accordingly, the scope of the invention is to be construed in accordance with the substance defined by the claims.

1. A resonant converter circuit comprising:
a first switch network;
a first transformer having a first winding connected to the first switch network;
a second switch network;
a second transformer having a first winding connected to the second switch network; and
a loop comprising an inductor, a capacitor, a second winding of the first transformer and a second winding of the second transformer.

2. The resonant converter circuit of claim 1, wherein:
the first switch network has a DC input and is a half-bridge converter, a full-bridge converter, a push-pull converter or a multilevel converter; and
the second switch network has a DC output and is another half-bridge converter, another full-bridge converter, another push-pull converter or another multilevel converter.

3. The resonant converter circuit of claim 1, wherein switches in the first and second switch networks realize soft switching.

4. The resonant converter circuit of claim 1, wherein:
the first switch network has an AC input and comprises a full-bridge converter with power switches or bidirectional switches, a matrix converter or a multilevel converter; and
the second switch network has an AC output and is another full-bridge converter with other power switches or other bidirectional switches, a matrix converter or another multilevel converter.

5. The resonant converter circuit of claim 4, wherein the first switch network and the second switch network both switch at a frequency at least 10 times a frequency of the AC input.

6. The resonant converter circuit of claim 1, wherein the first switch network has an AC input and comprises:
a full-bridge active rectifier;
a smoothing capacitor connected in parallel across an output of the full-bridge active rectifier; and
a full-bridge inverter or a multilevel converter, having inputs connected across the smoothing capacitor.

7. The resonant converter circuit of claim 1, further comprising:
a first port connected to the first switch network; and
a second port connected to the second switch network;
wherein:
the second port provides an output power when the first port receives an input power; and
the first port provides another output power when the second port receives another input power.

8. The resonant converter circuit of claim 1, further comprising:
a third switch network; and
a third transformer having a first winding connected to the third switch network;
wherein the loop further comprises a second winding of the third transformer.

9. The resonant converter circuit of claim 8, further comprising a port connected to each of the switch networks wherein:
at least one of the ports receives power; and
at least one other of the ports outputs power.

10. The resonant converter circuit of claim 9, wherein each port is switchable between receiving power and outputting power.

11. The resonant converter circuit of claim 1, further comprising:
a plurality of further switch networks; and
a corresponding plurality of further transformers each having a first winding connected to a different one of the plurality of further switch networks;
wherein the loop further comprises a second winding of each of the plurality of further transformers.

12. The resonant converter circuit of claim 11, further comprising a port connected to each of all said switch networks wherein:
at least one of the ports receives power; and
at least one other of the ports outputs power.

13. The resonant converter circuit of claim 12, wherein each port is switchable between receiving power and outputting power.

14. The resonant converter circuit of claim 1, wherein the first and second switch networks are multilevel converters.

15. The resonant converter circuit of claim 1, wherein:
the first switch network has an AC input and comprises a full-bridge converter with power switches or bidirectional switches, or a multilevel converter; and
the second switch network has a DC output and is a half-bridge converter, another full-bridge converter, a push-pull converter or another multilevel converter.

16. The resonant converter circuit of claim 1, further comprising:
two further first windings in the first transformer, each of which is connected to the first switch network;
two further second windings in the first transformer;
two further first windings in the second transformer, each of which is connected to the second switch network;
two further second windings in the second transformer; and
two further loops each comprising another inductor, another capacitor, one of the further second windings of the first transformer and one of the further second windings of the second transformer.

17. The resonant converter circuit of claim 16, wherein:
the first switch network is a three-phase full-bridge converter with power switches or bidirectional switches, or is a multilevel converter; and
the second switch network is another three-phase full-bridge converter with power switches or bidirectional switches, or is another multilevel converter.

18. The resonant converter circuit of claim 1, comprising an integrated magnetic assembly on which the first and second windings of the first and second transformers are wound.

19. A method for transferring power by a resonant converter circuit that comprises:
three or more ports;
three or more switch networks each connected to a different one of said ports;
three or more transformers each having a first winding connected to a different one of said switch networks; and
a loop comprising an inductor, a capacitor, and a second winding of each of said transformers;
the method comprising:
receiving two or more power inputs, each to a different one of said ports; and
switching each switch network that receives one of said power inputs so that it is switched with a phase difference relative to at least one other switch network that receives one of said power inputs.

20. A method for transferring power by a resonant converter circuit that comprises:
three or more ports;
three or more switch networks each connected to a different one of said ports;
three or more transformers each having a first winding connected to a different one of said switch networks; and
a loop comprising an inductor, a capacitor, and a second winding of each of said transformers;
the method comprising:
providing two or more power outputs, each from a different one of said switch networks via its corresponding port; and
switching each switch network that provides one of said power outputs so that it is switched with a phase difference relative to at least one other switch network that provides one of said power outputs.
